(19) United States
(12) Patent Application Publication
(10) Pub. No.: US 2024/0305598 A1
(43) Pub. Date: Sep. 12, 2024

(54) MESSAGE PROXYING AMONG MESSAGING SYSTEMS

(71) Applicant: Axiamatic Inc., Saratoga, CA (US)

(72) Inventors: Kaushik Narayan, Saratoga, CA (US); Rajiv Gupta, Los Altos, CA (US)

(21) Appl. No.: 18/338,883

(22) Filed: Jun. 21, 2023

Related U.S. Application Data
(60) Provisional application No. 63/451,440, filed on Mar. 10, 2023.

(51) Int. Cl. H04L 51/48; H04L 51/216

(52) U.S. Cl. CPC H04L 51/48; H04L 51/216

(57) ABSTRACT

Message proxying among messaging systems is disclosed, including: receiving a message sent from a user of a first messaging system; associating the message with a message thread; translating the message based at least in part on a persona associated with the user; and transmitting the translated message to a second messaging system.

### CROSS REFERENCE TO OTHER APPLICATIONS

This application claims priority to U.S. Provisional Patent Application No. 63/451,440 entitled MESSAGE PROXYING AMONG MESSAGING SYSTEMS filed Mar. 10, 2023 which is incorporated herein by reference for all purposes.

### BACKGROUND OF THE INVENTION

Two or more parties can communicate nearly instantaneously over a messaging platform. However, if the parties subscribe to different messaging platforms, then they may not be able to communicate to each other over the disparate messaging platforms. Furthermore, the subset of messages in a conversation on a messaging platform that pertain to a particular topic may be difficult to track as messages are typically displayed according to a static metric (e.g., in reverse chronological order). Moreover, if individuals in a conversation are acting at arms-length (e.g., because they work at different organizations and/or part of parties to a business relationship) with respect to each other, then the individuals' privacies may be infringed by displaying their actual names or otherwise personally identifying information within the conversation on a messaging platform. Therefore, it would be desirable to enable messaging between disparate parties across different messaging platforms and in a manner that addresses privacy concerns.

### BRIEF DESCRIPTION OF THE DRAWINGS

Various embodiments of the invention are disclosed in the following detailed description and the accompanying drawings.

FIG. 1 is a diagram showing an embodiment of a system for proxying messages among messaging systems.

FIG. 2 is a diagram showing an example of a message proxy server in accordance with some embodiments.

FIG. 3 is a flow diagram showing an example of a process for creating a message thread in accordance with some embodiments.

FIG. 4 is a flow diagram showing an embodiment of a process for message proxying.

FIG. 5 is a flow diagram showing an example of a process for message proxying in accordance with some embodiments.

FIG. 6 is a flow diagram showing an example of a process of message transmission in accordance with some embodiments.

FIG. 7 is a flow diagram showing an example of a process of modifying or deleting a message on a message thread in accordance with some embodiments.

FIG. 8 is a flow diagram showing an example of a process of implementing an address book for an originating user of a message in accordance with some embodiments.

FIGS. 9A and 9B show example user interfaces that can be provided by a message proxy server to enable a user to create a new message thread.

FIG. 10 is a diagram showing an example user interface that is provided by a messaging system that a member of a message thread has selected to use to interface with the message thread.

FIG. 11 is a diagram showing an example user interface that is provided by a messaging system that a member of a message thread has selected to use to interface with the message thread.

FIG. 12A is a diagram showing an example user interface that is provided by a messaging system that a member of a message thread has selected to use to interface with the message thread and at which the user has selected to create a new sub-thread corresponding to a new action.

FIG. 12B is a diagram showing an example user interface that is provided by a messaging system after the creation of a sub-thread corresponding to a new action.

FIG. 12C is a diagram showing an example user interface that is provided by a messaging system to present a separate window that includes messages that relate to the sub-thread corresponding to the new action.

FIG. 13 is a diagram showing an example user interface that is provided by a messaging system and at which the address book of the user is used to determine the available message recipients that the user can mention in a message to a message thread.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of message proxying among messaging systems are described herein. A message sent from a user of a first messaging system is received at a message proxy server. In some embodiments, the user of the first messaging system has a registered account with the first messaging system and a separate registered account with the message proxy server. In various embodiments, the underlying data/content of the message is not persisted/cached at the message proxy server but rather just a message identifier (ID) that is provided by the first messaging system. The message is associated with a message thread by the message proxy server. In various embodiments, a “message thread” comprises a messaging construct that is maintained by the message proxy server and is associated with messages that are submitted/posted by users across two or more organizations and/or two or more messaging systems/platforms. In some embodiments, a “message thread” includes a message “channel.” In some embodiments, the user is associated with a first organization and has transmitted the message, via a user interface that is provided by the first messaging system, to a message thread that includes user(s) from both the first organization and user(s) from at least a second organization. The user(s) from at least the second organization that are part of the message thread each have registered accounts with the second messaging system and the message proxy server. In various embodiments, using the received message identifier, the message proxy server is configured to retrieve the message content from the first messaging system and translate the message. In various embodiments, translating the message includes translating the underlying message content based on the native message formats/constructs associated with the second messaging system, if the second messaging system is different from the first messaging system. In various embodiments, translating the message includes translating the identifying information associated with the sender user based on the specified obfuscation level associated with the message thread or a relationship between the first and second organization. The translated message is then transmitted to the second messaging system. In various embodiments, in response to receiving the translated message that is associated with the message thread, the second messaging system is configured to send the translated message to one or more devices of user(s) associated with the second organization that are participants/members in that message thread.

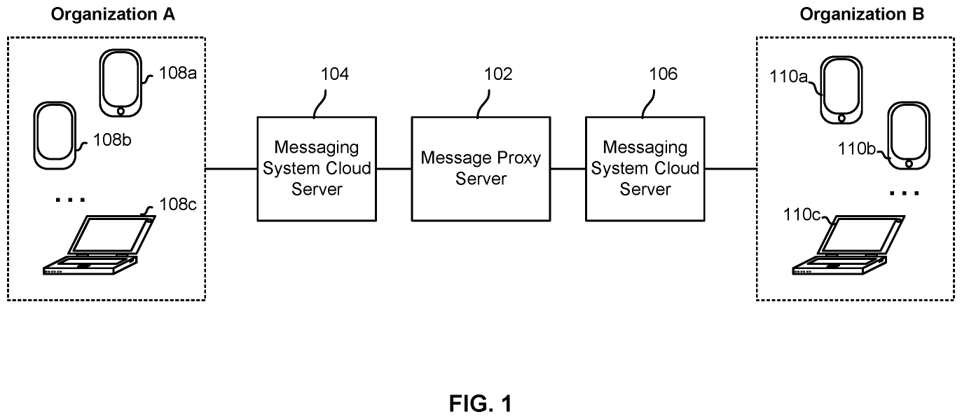

FIG. 1 is a diagram showing an embodiment of a system for proxying messages among messaging systems. In the example of FIG. 1, message proxy server 102 is configured to proxy messages between messaging system cloud server 104 and messaging system cloud server 106 over a network (not shown in FIG. 1). For example, the network comprises data or telecommunications networks. While message proxy server 102 is shown to be proxying messages between only two messaging system cloud servers in FIG. 1, in actual implementation, message proxy server 102 can proxy messages across two or more messaging system cloud servers. In FIG. 1, messaging system cloud server 104 can represent one or more cloud servers that operate in concert to run the services associated with a first messaging platform. Similarly, messaging system cloud server 106 can represent one or more cloud servers that operate in concert to run the services associated with a second messaging platform. In various embodiments, the first messaging platform associated with messaging system cloud server 104 is different from the second messaging platform associated with messaging system cloud server 106. Specifically, the first messaging platform associated with messaging system cloud server 104 may differ from the second messaging platform associated with messaging system cloud server 106 by providing different native messaging features, supporting different formats of messages, and/or providing a different user interface for sending a message or viewing a received message for an end user, for example.

In the example shown in FIG. 1, the users that use devices 108a, 108b, and 108c are associated with Organization A and the users that use devices 110a, 110b, and 110c are associated with Organization B. For example, Organization A and Organization B can be two disparate enterprises and for which the personnel of Organization A are communicating to each other using a first messaging platform and the personnel of Organization B are communicating to each other using a second messaging platform. However, there are instances in which the personnel of Organization A may want to communicate with personnel at Organization B due to an established relationship between Organizations A and B but their disparate messaging platforms do not enable cross platform communication. One example relationship between Organizations A and B is that one organization is a vendor of a product (e.g., a software as a service) that is used/consumed by the other organization and as such, it would be desirable to enable the users of one organization (e.g., the consumer) and/or messaging platform to send messages to and receive messages from the other organization and/or other messaging platform to seek customer support and request additional features from the other organization (e.g., the vendor). Various embodiments to proxy messages between two (or more) messaging systems/platforms via a message thread construct that is maintained by message proxy server 102 is described herein.

As shown in FIG. 1, message proxy server 102 is configured to maintain a message thread construct that is associated with messages that are exchanged between users (that use user devices 108a, 108b, and 108c) of the first messaging platform associated with messaging system cloud server 104 and users (that use user devices 110a, 110b, and 110c) of the second messaging platform associated with messaging system cloud server 106. Each of 108a, 108b, 108c, 110a, 110b, and 110c may be a computer, a mobile device, a tablet device, and/or any computing device. Put another way, message proxy server 102 is configured to maintain a message thread that comprises members that are made up of users of each of two or more disparate messaging platforms.

Message proxy server 102 is configured to copy and transmit a message associated with a message thread that is initially received at a first messaging platform to the messaging system cloud server associated with a second messaging platform. In various embodiments, a user (e.g., associated with device 108a) associated with Organization A can send a message to the message thread with users of Organization B by submitting a message to messaging system cloud server 104 via a user interface that is provided by messaging system cloud server 104 corresponding to the message thread. In some embodiments, messaging system cloud server 104 is configured to maintain a first messaging platform-specific object that corresponds to that particular message thread. The first messaging platform-specific object can be used by the first messaging platform to track messages posted by first messaging platform users to the message thread. Message proxy server 102 is configured to connect (e.g., via a first application programming interface (API)) to messaging system cloud server 104 to detect whether a new message has been received at messaging system cloud server 104 that is associated with the first messaging platform object. If so, then message proxy server 102 is configured to associate that particular message with the message thread between the users (that use devices 108a, 108b, and 108c) of the first messaging platform associated with messaging system cloud server 104 and users (that use devices 110a, 110b, and 110c) of the second messaging platform associated with messaging system cloud server 106. In addition to maintaining message schema and properties that are specific to each messaging platform, message proxy server 102 is also configured to maintain personas associated with each user in the context of the organization with which the user is associated. As will be described in further detail below, a “persona” is a role of a user with respect to a particular relationship between two or more organizations and/or within a particular message thread. Each different persona has a corresponding set of permissions with respect to the message thread such as, for example, types of features they can initiate with respect to the message thread and to which other message thread members they are permitted to send messages. As such, in response to the detection of the identifier of a new message from messaging system cloud server 104 being associated with the message thread, message proxy server 102 is configured to fetch the underlying data of the new message from messaging system cloud server 104 and translate that data based on the message schema and properties of the destination messaging system associated with messaging system cloud server 106. Message proxy server 102 is further configured to translate the new message by obfuscating the identifying information associated with the sender user based on the sender user's persona and a selected identity obfuscation level associated with the message thread. Message proxy server 102 is then configured to transmit (e.g., via a second API) the translated underlying data of the message along with the sender user's obfuscated identifying information to messaging system cloud server 106. Message proxy server 102 can also instruct messaging system cloud server 106 to associate the translated message and sender user identifier with a second messaging platform-specific object that corresponds to that particular message thread. The second messaging platform-specific object can be used by the second messaging platform to track messages sent to or posted by second messaging platform users of the message thread. Given that the translated message has been associated with the second messaging platform-specific object, messaging system cloud server 106 is configured to send the translated message to one or more of the devices 110a, 110b, and 110c that are respectively associated with users of Organization B that are part of that message thread. The recipient users will be presented with the translated message and obfuscated send user identity within the main message feed window of a user interface that is provided by messaging system cloud server 106 on their respective devices 110a, 110b, and 110c. In various embodiments, message proxy server 102 does not persist a message that it fetches from one messaging system cloud server associated with a first messaging platform and then translates/transmits to another messaging system cloud server associated with a second messaging platform and is therefore a “stateless” proxy.

In various embodiments, message proxy server 102 is configured to filter out select messages that are received at the first messaging platform associated with messaging system cloud server 104 by not sending the selected messages to the second messaging platform associated with messaging system cloud server 106, and vice versa. For example, the sender user can designate (e.g., via a hashtag associated with the sent message) which messages are to be sent to the message thread and that will be transmitted to the destination messaging platform and presented to the message thread members associated with the destination messaging platform. The sender user can also designate which messages are to be sent to the message thread but that will not be transmitted to the destination messaging platform and instead, only presented within the message thread in the user interface that is presented by the first messaging platform (e.g., for only users of the first messaging platform that are members of the message thread to view). The messages that are designated to not be sent from the messaging system cloud server associated with a first messaging platform to the messaging system cloud server associated with the second messaging platform are considered to be “private” to the members of the message thread that are users of the first messaging platform.

In various embodiments, message proxy server 102 is configured to maintain a sub-thread construct associated with a message thread construct. For example, a sub-thread of a message thread may include a subset of messages belonging to the message thread that pertain to a particular topic, action, or request made by a first set of members (e.g., associated with a first organization) of a second set of members (e.g., associated with a second organization) of the message thread. As will be described in further detail below, a user of a first messaging platform that is a party to the message thread can initiate the creation of a sub-thread within a message thread in the user interface that is provided by the first messaging platform (e.g., via an installed plugin to the first messaging platform that was downloaded from message proxy server 102). In response to the creation of the sub-thread, message proxy server 102 is configured to instruct both the messaging platform cloud server associated with the first messaging platform and the messaging platform cloud server associated with at least a second messaging platform with user(s) that are participants of the message thread to each create their respective sub-thread objects that are to be associated with their own messaging platform-specific object that corresponds to that particular message thread. Thereafter, members of the message thread can send messages via the user interface of their messaging platform specifically to the sub-thread of the message thread such that messages that are specific to the sub-thread can be presented in a separate window relative to the main window that shows the feed of all messages of the message thread within the user interface of a messaging platform. For example, if the sub-thread related a particular time sensitive request by a first set of members from a second set of members of the message thread, then the sub-thread can efficiently track messages between the two sets of members related to that particular request and its progress.

While FIG. 1 describes a message thread that is created between users of two organizations and/or two messaging platforms, the techniques described in various embodiments can be extended to a message thread that is created among users of three or more organizations and/or across three or more message platforms.

As such, message proxy server 102 operates as a stateless intermediary/proxy of messages associated with a message thread across two or more disparate messaging platforms because message proxy server 102 does not persist or cache the underlying content of such messages. Furthermore, message proxy server 102 is configured to leverage each messaging platform's native messaging features to enable cross-message platform messaging but with added layers of identification obfuscation/anonymization, the addition of sub-threads within a message thread, and persona constructs to ensure seamless communication across users of disparate messaging platforms and/or disparate organizations.

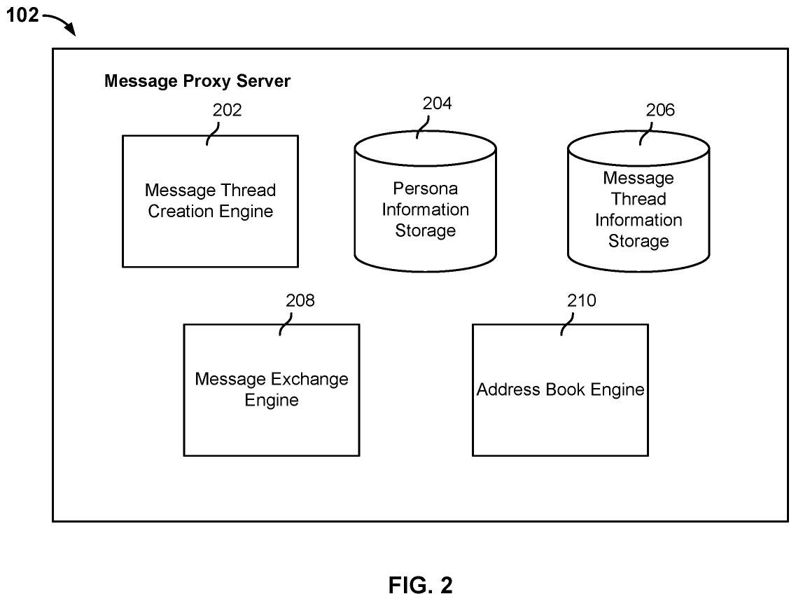

FIG. 2 is a diagram showing an example of a message proxy server in accordance with some embodiments. In the example of FIG. 2, the message proxy server includes message thread creation engine 202, persona information storage 204, message thread information storage 206, message exchange engine 208, and address book engine 210. Each of message thread creation engine 202, persona information storage 204, message thread information storage 206, message exchange engine 208, and address book engine 210 can be implemented using hardware and/or software. In some embodiments, message proxy server 102 of FIG. 1 can be implemented using the example message proxy server of FIG. 2.

Message thread creation engine 202 is configured to create a message thread between users of each of two or more messaging systems. In various embodiments, a “messaging system” represents one or more messaging system cloud servers that act in concert with one another to implement the messaging services associated with a corresponding messaging platform. In some embodiments, message thread creation engine 202 is configured to provide a user interface associated with message proxying at a device used by a user with an account at the message proxying service. The user can interact with the user interface to create/set up a new message thread. In some embodiments, the user, who is associated with (e.g., employed at) a first organization, can indicate at the message proxying service user interface that the new message thread is to be associated with a particular second organization and/or a particular product provided by the second organization (e.g., because the first organization is a consumer of that product). In some embodiments, the new message thread can be associated with two or more parties (e.g., an example three party scenario is a consumer organization, a vendor organization, and an integrator organization). The user can also select, at this user interface, a first messaging system through which the user will be sending and receiving messages on the message thread. For example, the user has already separately created an account with the selected messaging system. At this message proxying service user interface, the user can specify which other users, if any, that are part of the first organization to add as additional members to the message thread and also, each member's persona's with respect to the relationship between the first and second organizations and/or the message thread. In various embodiments, which personas are available to be selected for any organization or each party of a particular relationship between organizations (e.g., consumer and vendor; co-collaborators on a project) are described in persona information storage 204. Persona information storage 204 can be updated to add new personas, modify existing personas, and/or delete existing personas. Persona information storage 204 can also store, for each specified persona, the types of permissions that a user of that persona has with respect to what features of the message thread they can initiate and/or which other personas to which they can directly message or specifically mention within the message thread. For example, the selected additional members also already have separately created accounts with the selected first messaging system. Additionally, at this message proxying service user interface, the user can select an identity obfuscation level to be associated with the message thread. In various embodiments, the “identity obfuscation level” determines the degree to which a user identity is obfuscated within the user interface of the destination messaging system. For example, the greater the identity obfuscation level that is selected, the more difficult it will be to personally identify the sender user of a message after the sender user's identity is translated/obfuscated accordingly during the transmission of a message associated with a message thread from a first messaging server to a second messaging server. In response to the first messaging system's user's request to create a new message thread, message thread creation engine 202 is configured to instruct (e.g., via an API that is provided by the first messaging system and credentials provided by the first organization) the first messaging system to create a new first messaging system-specific object associated with the new message thread and also associate all of the selected users, which are associated with the first organization, with that first messaging system-specific object associated with the new message thread.

In creating the new message thread that is initiated by a user of a first organization to include member(s) of a second organization, message proxy server 102 is configured to send a prompt to a user of the second organization to invite the user of the second organization to set up members of the second organization that are to be part of the new message thread. Message thread creation engine 202 is configured to provide a message proxying service user interface to the user of the second organization to enable that user to add zero or more other users of the second organization to add as members of the message thread, respective personas (e.g., selected from the options provided in persona information storage 204) corresponding to the second organization members, and a selected second messaging system from which the second organization members will use the user interface of to send messages to and receive messages from the message thread. For example, the selected second organization members of the new message thread also have already separately created accounts with the selected second messaging system. In response to the message thread set up information that is provided by the user associated with the second organization, message thread creation engine 202 is configured to instruct (e.g., via an API that is provided by the second messaging system and credentials provided by the second organization) the second messaging system to create a new second messaging system-specific object associated with the new message thread and also associate all selected users, which are associated with the second organization, with that second messaging system-specific object associated with the new message thread.

After instructing the first messaging system and the second messaging system to create respective messaging system-specific objects corresponding to the new message thread, the first organization/first messaging system members of the new message thread can use the first messaging system's messaging user interface to send and receive messages within the message thread, and also view messages of the message thread that are public to them. Furthermore, the second organization/second messaging system members of the new message thread can use the second messaging system's messaging user interface to send and receive messages within the message thread, and also view messages of the message thread that are public to them. Which messages that are sent to the message thread and that are to be translated and transmitted from the originating messaging system to the destination messaging system (and therefore, become presented within the destination messaging system's messaging user interface to the destination messaging system members of the message thread) can be determined, translated, and transmitted by message exchange engine 208, as will be described in further detail below.

Further in creating the new message thread, message thread creation engine 202 is configured to create a new message thread construct and store information related to the new message thread construct at message thread information storage 206. In some embodiments, for a message thread, message thread information storage 206 is configured to store information on one or more of the following: the users of a first messaging system and/or first organization that are members of the message thread, the users of a second messaging system and/or second organization that are members of the message thread, the persona associated with each member of the message thread, the selected identity obfuscation level associated with the message thread, a relationship between the first organization and the second organization, a type of filtration that is to be used to messages posted to the message thread, and the current status of each sub-thread that has been created within the message thread.

After messages posted/sent to the message thread are exchanged between the first messaging system and the second messaging system by message exchange engine 208, for the message thread, message thread information storage 206 can also store the mappings of an exchanged/transmitted message's first messaging system-specific message identifier and its second messaging system-specific message identifier. For example, a message that is posted to a message thread by a user of the first messaging system will be associated with the first messaging system object that was created for that message thread and also assigned a first messaging system-specific identifier by the first messaging system. If this message is determined by message exchange engine 208 to be translated and transmitted to the second messaging system, then the transmitted message is then associated with the second messaging system object that was created for that message thread and also assigned a second messaging system-specific identifier. Such mappings of message-specific identifiers related to the same message can be used for the modification or deletion of messages that are sent to the message thread and that are exchanged from one messaging system to another by message exchange engine 208. In various embodiments, message thread information storage 206 does not store the underlying data of any message that has been posted to the message thread.

Message exchange engine 208 is configured to query, using APIs provided by the respective messaging systems, each of various messaging systems for whether a new message has been posted to any objects that they have maintained corresponding to a respective message thread. In some embodiments, when a member of a message thread posts a message to that message thread, the user submits the message via a user interface that is provided by a messaging system that is used by that member. As such, the submitted message will be associated with that messaging system's object that is generated for that message thread and will also be assigned a message identifier by the messaging system. In various embodiments, messages that are posted to the messaging system's object that is generated for that message thread will be presented/visible to members of the message thread that are also users of that messaging system. Message exchange engine 208 can (e.g., periodically) query each messaging system for whether a new message has been received for the messaging system's object that is generated for each message thread and if a message has been received, message exchange engine 208 is configured to obtain the identifier associated with the message. In response to the detection of a new message being posted to a message thread from a first messaging platform, message exchange engine 208 is configured to first determine whether the message should be transmitted/copied to a second, destination message platform and therefore, become presented/visible to members of the same message thread that are also users of the second messaging system. For example, message exchange engine 208 can determine whether or not to transmit a message from a source messaging system to a destination messaging system in the event that there is a setting associated with the message thread that indicates to filter (i.e., not transmit/copy) all messages posted from the source messaging system unless the message included a designated type of text (e.g., a specified hashtag). In the event that the new message is to be filtered (i.e., not transmitted/copied to) a destination messaging system, message exchange engine 208 is configured to not translate or transmit the message to a destination messaging system and as a result, the new message will only be visible within the main message feed in the user interface of the source messaging system.

In the event that the new message is to be transmitted/copied from the source messaging system to a destination messaging platform, message exchange engine 208 is configured to determine whether the message includes a request to generate a sub-thread within the message thread. In various embodiments, a sub-thread can be requested to be associated with a particular action that is requested by the source messaging system member(s) of the message thread of a destination messaging system member(s) of the message thread. For example, the requested action is for the destination messaging system member(s) of the message thread to provide customer support for a problem that has come up with respect to a product that is provided by an organization associated with the destination messaging system member(s) of the message thread. In the event that the message includes a request to generate a sub-thread within the message thread, message exchange engine 208 is configured to instruct (e.g., via an API provided by the source messaging system) the source messaging system to generate a new, corresponding sub-thread object and also to instruct (e.g., via an API provided by the destination messaging system) the destination messaging system to generate a new, corresponding sub-thread object. Message exchange engine 208 is also configured to track the current status associated with the requested action (e.g., when the action is requested to be completed, whether the action has been completed/closed) of the sub-thread of the message thread in message thread information storage 206. Once a sub-thread has been created within the message thread, messages that are specific to the sub-thread (or the requested action therein) can be posted/presented in either of the source or destination messaging system's user interface in a window that is separate from the main window that presents all the messages (that are visible to the viewing user). Put another way, the sub-thread allows a grouping of a subset of messages in the message thread that are associated with a particular topic (e.g., a requested action) to be presented/submitted via a separate window.

Furthermore, in the event that the new message is to be transmitted/copied from the source messaging system to a destination messaging platform, message exchange engine 208 is configured to translate the message before transmitting it to the destination messaging system. In various embodiments, message exchange engine 208 is configured to obtain and translate the content/underlying data of the message based on the destination messaging system's message schema. For example, the font, formatting, and/or display properties of the message content can be translated into compatible versions or at least partially disabled (if not supported at the destination) in the translation to become a destination messaging system-specific message. In various embodiments, message exchange engine 208 is configured to obtain and translate the sender user identity based on the sender user identity's persona and the selected identity obfuscation level of the message thread. For example, while the sender user's identity is known to message exchange engine 208 due to the user having previously created an account with the message proxy server, the selected identity obfuscation level of the message thread may be such that an obfuscation of the sender user's identity of a message is desired for a message that is to be transmitted/copied to a destination messaging system (e.g., for the purpose of protecting the sender user's identity to message thread members of a different messaging system or different organization). Obfuscating the sender user's identity may include showing only a portion of the sender's identity (e.g., only showing a first name or using one or more initials), showing only the persona of the sender user's identity, or showing only the persona of the sender user's identity followed by a unique value that is uniquely assigned by message exchange engine 208 to the sender user. After message exchange engine 208 translates the message's data and also the sender user's identity, message exchange engine 208 sends the translated message to the destination messaging system to associate with the destination messaging system's object associated with the message thread. Once the translated message is associated with the destination messaging system's corresponding object, the translated message (along with its translated/obfuscated sender user identity) can be sent to/presented within the destination messaging system's user interface for each member of the message thread that is a user of the destination messaging system. As mentioned above, if the translated message was submitted for a sub-thread within the message thread, then the message can also be associated with each of the source/destination messaging system's object that is associated with that sub-thread. By transmitting the translated message to the destination messaging system, message exchange engine 208 is configured to receive a message identifier that is assigned by the destination messaging system to the message. In response, message exchange engine 208 is configured to store for the message, the mapping between its source messaging system assigned message identifier and its destination messaging system assigned message identifier.

Address book engine 210 is configured to determine, for a given member of a message thread, which of the other members of the message thread they can mention (e.g., via a “@” symbol) within a message submitted to the message thread. In various embodiments, mentioning another member of the message thread within a message will result in a notification being sent to the mentioned member (e.g., to specifically draw their attention to the message). In various embodiments, in response to a given member selecting to mention another member (e.g., by typing the designated symbol for creating a mention within a message that they are composing in the submission field), address book engine 210 is configured to determine the persona associated with that given member (e.g., that is stored at message thread information storage 206), and which other personas that the persona has permission to mention (e.g., based on the persona-to-persona permissions that are described in persona information storage 204). The other members with personas that the given member can mention based on the given member's persona can be determined and their identities can be presented as available selections/mention candidates for the given member to select at least one among which to mention within the message. In some embodiments, address book engine 210 can further obfuscate the identities of these mention candidates based on the selected obfuscation level associated with the message thread.

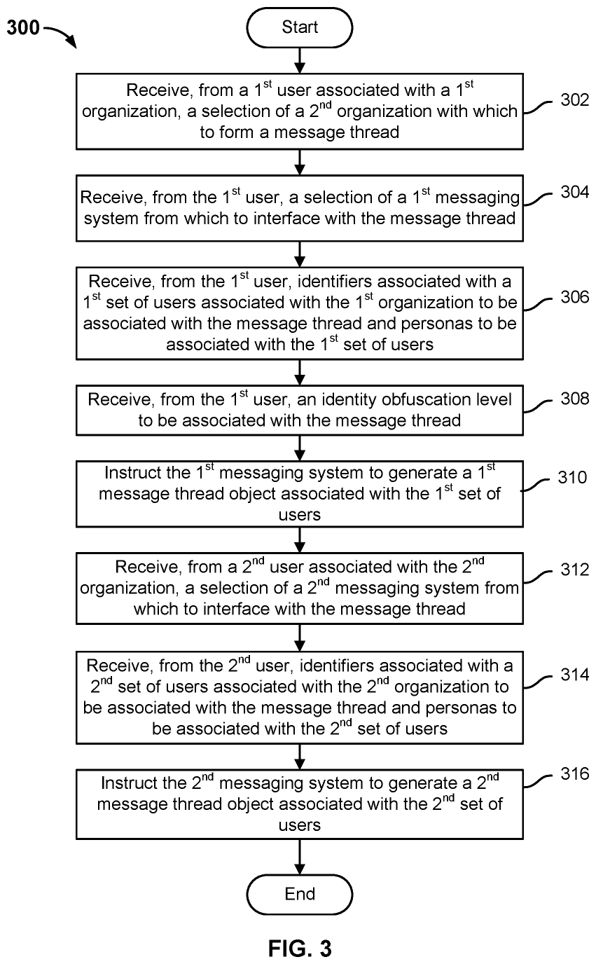

FIG. 3 is a flow diagram showing an example of a process for creating a message thread in accordance with some embodiments. In some embodiments, process 300 is implemented, at least in part, by a message proxy server such as message proxy server 102 of FIG. 1.

At 302, a selection of a second organization with which to form a message thread is received from a first user associated with a first organization. A user that is a member of the personnel of a first organization (e.g., enterprise) can access the user interface, using a user device (e.g., mobile or desktop device), of the message proxy server that is provided by the message proxy server to create a new message thread (or sometimes referred to as “message channel”) between the personnel of the first organization and personnel of a second organization. For example, the second organization comprises a partner of the first organization or is another, disparate organization with which personnel of the first organization would like to communicate using messages using the first organization's already adopted messaging system. In a specific example, the second organization comprises a vendor of a product that is used/purchased by the first organization and user(s) of the organization would like to establish a message thread with user(s) of the second organization/vendor in which they could provide feedback on the product and/or seek customer support on the product.

At 304, a selection of a first messaging system from which to interface with the message thread is received from the first user. The user that is creating this new message thread can select a messaging system to use to interface with the message thread, which will be formed with user(s) of the second organization, which may select a different second messaging system from which to interface with the message thread. To use a selected messaging system to interface with the message thread includes using the native user interface that is provided by the selected messaging system to send messages to and receive messages from the message thread. For example, the user that is creating this new message thread may select the messaging system that the first organization has already adopted (e.g., at the enterprise-level) for its personnel to communicate through.

At 306, identifiers associated with a first set of users associated with the first organization to be associated with the message thread and personas to be associated with the first set of users are received. The user that is creating this new message thread can provide identifiers of other users associated with the first organization to add as additional members of the message thread. The user is to then provide a persona corresponding to each member of the message thread that is from the first organization. As mentioned above, a “persona” refers to a role of a user with respect to a particular relationship between two or more organizations and/or within a particular message thread. In some embodiments, personas can be defined users of an organization that are a specified type of party within a relationship. For example, personas can be defined for users associated with a consumer party and different personas can also be defined for the users that are associated with a vendor party in a consumer-vendor relationship. Each persona is associated with a configurable/definable set of permissions. The permission of a particular persona pertains to, for example, which other personas (associated with a different organization) that the persona can mention in a message or directly message and which features that the persona can access with respect to the message thread (e.g., whether the persona can create/modify a sub-thread within the message thread).

At 308, an identity obfuscation level to be associated with the message thread is received from the first user. The user that is creating this new message thread can set a desired identity obfuscation level to be associated with the message thread and this identity obfuscation level will be used to determine if and how the identity of a sender user of a message that is posted to the message thread is to be translated/obfuscated in the event that the message is determined to be transmitted from one messaging system to the other messaging system. For example, while the sender user's identity is known to the message proxy server due to the user having previously created an account with the message proxy server, the selected identity obfuscation level of the message thread may be such that an obfuscation of the sender user's identity of a message is desired for a message that is to be transmitted/copied to a destination messaging system (e.g., for the purpose of protecting the sender user's identity to message thread members of a different messaging system or different organization). Obfuscating the sender user's identity may include showing only a portion of the sender's identity (e.g., only showing a first name or using one or more initials), showing only the persona of the sender user's identity, or showing only the persona of the sender user's identity followed by a unique value that is uniquely assigned by the message proxy server to the sender user. For example, for the third example type of identity obfuscation level described above, if the sender user were Jeff Smith of Organization A and Jeff Smith had the persona of “Economic Buyer,” then his identity that is presented with a message that he sends to the message thread that is visible to a member of the message thread of a different organization, Organization B, could be presented as “Economic Buyer 23.” In this way, Jeff Smith could be consistently identified to other users (of a different organization) as “Economic Buyer 23” across any message thread in which he is a member without having his personal information becoming exposed.

At 310, the first messaging system is instructed to generate a first message thread object associated with the first set of users. The first messaging system is then instructed/requested, via an API provided by the first messaging system, to create a new object corresponding to the message thread. In some embodiments, credentials that were previously provided by the first organization to the message proxy server are also provided by the message proxy server to the first messaging system to enable the first messaging system to grant the message proxy servers' request.

At 312, a selection of a second messaging system from which to interface with the message thread is received from a second user associated with the second organization. In response to the user of the first organization initiating the creation of the message thread, the message proxy server is configured to send a prompt to one or more users associated with the second organization to notify the user(s) of the creation of the message thread. The notified users are then invited to use the user interface of the message proxy server to select a messaging system that users of the second organization are to use to interface with the message thread. The messaging system that is selected by the user of the second organization can be the same messaging system (e.g., messaging platform) that was selected by the first organization or be a different messaging system. For example, the user that is creating this new message thread may select the messaging system that the second organization has already adopted (e.g., at the enterprise-level) for its personnel to communicate through.

At 314, identifiers associated with a second set of users associated with the second organization to be associated with the message thread and personas to be associated with the second set of users are received from the second user. The user(s) associated with the second organization are further invited to provide identifiers of other users associated with the second organization to add as additional members of the message thread. The user is to then provide a persona corresponding to each member of the message thread that is from the second organization.

At 316, the second messaging system is instructed to generate a second message thread object associated with the second set of users. The second messaging system is then instructed/requested, via an API provided by the second messaging system, to create a new object corresponding to the message thread. In some embodiments, credentials that were previously provided by the second organization to the message proxy server are also provided by the message proxy server to the second messaging system to enable the second messaging system to grant the message proxy server's request. The message proxy server can then also generate and maintain its own message proxy construct corresponding to the new message thread and also store corresponding information (e.g., the identities of the members, the members' persona, the members' associated organizations, mappings of messaging system IDs for messages that are exchanged between messaging systems) corresponding to the new message thread. Before or after the creation of the new message thread, users of the first and second messaging systems that are to become members of the message thread can download software (e.g., a plugin) from the message proxy server that can provide additional message proxy service related functionalities (e.g., requesting to create a sub-thread corresponding to an action) to the native messaging software that is provided by the messaging system.

After the creation of the new message thread, the members of the message thread that are associated with the first organization can use the user interface provided by the first messaging system to submit messages to the message thread. The messages submitted to the message thread via the user interface of the first messaging system are then potentially translated and copied by the message proxy server to the second messaging system, where the translated message is distributed by the second messaging system to the user devices of the members of the message thread that are associated with the second organization. Likewise, the messages submitted to the message thread via the user interface of the second messaging system are then potentially translated and copied by the message proxy server to the first messaging system, where the translated message is distributed by the second messaging system to the user devices of the members of the message thread that are associated with the first organization.

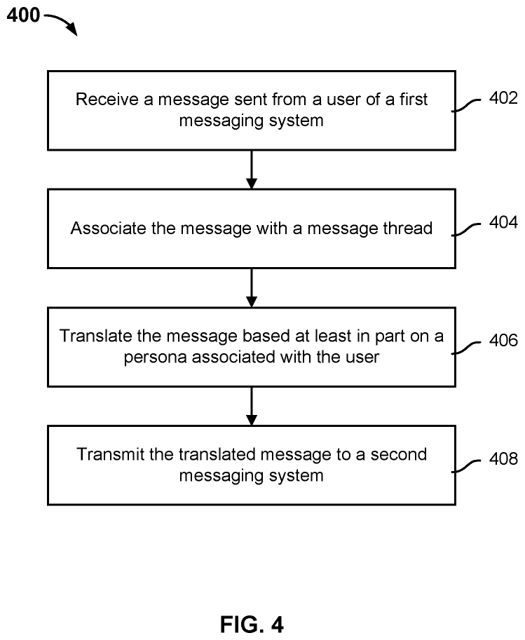

FIG. 4 is a flow diagram showing an embodiment of a process for message proxying. In some embodiments, process 400 is implemented, at least in part, by a message proxy server such as message proxy server 102 of FIG. 1.

At 402, a message sent from a user of a first messaging system is received. A first messaging system is periodically or in response to an event, queried (e.g., using an API provided by the first messaging system) for whether a new message has been received at the first messaging system from a user of the first messaging system. The new message is assigned a message identifier that is generated by the first messaging system. In the event that a new message at the first messaging system has been determined, the message identifier of the new message is obtained by the message proxy server.

At 404, the message is associated with a message thread. Based on the message identifier of the new message, the message proxy server can determine whether the message is associated with a message thread (e.g., that was created using a process such as process 300 of FIG. 3). For example, if the message identifier were associated with a first messaging system object that was generated for a message thread, then it is determined that the message is associated with a message thread.

At 406, the message is translated based at least in part on a persona associated with the user. In some embodiments, it is first determined whether or not the message is to be transmitted at all to a second (e.g., destination) messaging system. For example, whether the message is determined to be transmitted from the first to the second messaging system is based on the underlying data of the messaging containing a predetermined piece of text (e.g., preceded by a symbol such as a hashtag for example). In this example, a message that does not include this predetermined piece of text is not copied to the second messaging system.

In the event that the message is determined to be transmitted to the second messaging system, the underlying data of the message is translated based at least in part on the message formatting that is permitted by the second messaging system. A messaging system's message formatting can describe permitted formatting, not supported formatting, supported message features (e.g., messages that include one or more of images, tables, audio, video), and/or not supported message features. For example, conversion rules between pairs of disparate messaging systems can be configured in advance and the underlying data of a message that is originated from the first messaging system can be translated based on the conversion rules between the first and second messaging systems. Furthermore, in some embodiments, the identity of the user that had sent the message can be translated/obfuscated based on the selected identity obfuscation level associated with the message thread. As mentioned above, translating/obfuscating a sender user's identity includes generating an obfuscated version of the sender user's identity such that the resulting translated/obfuscated version may not personally identify the sender user and potentially, instead, provides an identifier that is determined based on the sender user's persona with respect to the message thread.

At 408, the translated message is transmitted to a second messaging system. The translated underlying message data and the translated/obfuscated sender user identity are transmitted to the second messaging system and are to be associated with the second messaging system object that is associated with the same message thread. The message proxy server will not persist or cache the translated or not translated underlying data of the message. As a result of transmitting the translated underlying message data and the translated/obfuscated sender user identity to the second messaging system, the second messaging system is configured to distribute the translated underlying message to the user devices of the users of the second messaging system that are also members of this message thread.

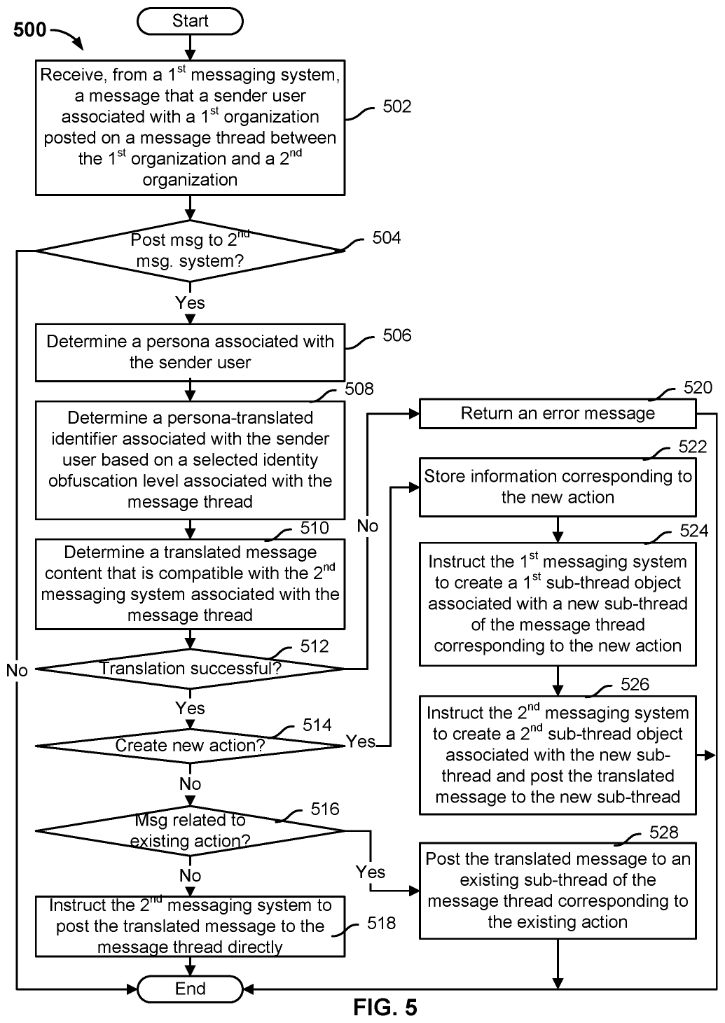

FIG. 5 is a flow diagram showing an example of a process for message proxying in accordance with some embodiments. In some embodiments, process 500 is implemented, at least in part, by a message proxy server such as message proxy server 102 of FIG. 1. In some embodiments, process 400 of FIG. 4 is implemented, at least in part, using process 500.

Process 500 describes an example process of performing message proxying on a message associated with a message thread that is initially received at a first messaging system, including by determining whether the message should be transmitted to a second messaging system and/or if the message comprises a request to create a new action/sub-thread within the message thread.

At 502, a message that a sender user associated with a first organization posted on a message thread between the first organization and a second organization is received from a first messaging system. The sender user composed and sent the message via a user interface that is provided by the first messaging system. The sent message is associated with a message thread object that was created by the first messaging system for this message thread. The message proxy server can determine that the message has been posted to this message thread by querying its corresponding object that is maintained by the first messaging system. For example, the message proxy server can determine that a new message is associated with the first messaging system message thread object in the event that the object is associated with a new message identifier.

At 504, whether the message is to be posted to a second messaging system associated with the message thread is determined. In the event that the message is to be posted to a second messaging system associated with the message thread, control is transferred to 506. Otherwise, in the event that the message is not to be posted to a second messaging system associated with the message thread, process 500 ends. For example, whether the message is to be copied over to one or more other messaging systems can be determined based on the content of the message. In a specific example, if the content of the message included a predetermined phrase (e.g., and is preceded by a predetermined symbol), then the message is determined to be transmitted from the first messaging system to at least one other messaging system so that the message can be presented to message thread members and members of those other messaging system(s) through the user interfaces that are provided by those other messaging systems. Otherwise, if the message is not to be transmitted to one or more other messaging systems, then the message can be considered to be privately shared among only members of the message thread that are also users of the first messaging system.

At 506, a persona associated with the sender user is determined. The persona of the sender user is stored by the message proxy server with other information associated with the members of the message thread.

At 508, a persona-translated identifier associated with the sender user is determined based on a selected identity obfuscation level associated with the message thread. A type of translation that occurs with respect to the message is the translation/obfuscation of the identifier of the sender user based on the selected identity obfuscation level associated with the message thread. The selected identity obfuscation level dictates the degree to which the identifier of the sender user should be obfuscated, if at all, such that the resulting translated sender user identity cannot be used easily or at all to personally identify the sender user.

At 510, a translated message content that is compatible with the second messaging system associated with the message thread is determined. The underlying data and/or metadata of the message is translated to be compatible with the message formatting that is used by each of the second messaging system and/or other messaging system to which the translated message will be transmitted based on predetermined conversion rules of one messaging system's formatting to another messaging system's formatting. In some embodiments, translating the message content may include disabling or discarding a portion of the message that is not compatible with or supported by a recipient messaging system's message formatting.

At 512, whether the translation of the message was successful is determined. In the event that the translation of the message was successful, control is transferred to 514. Otherwise, in the event that the translation of the message was not successful, control is transferred to 520. For example, a message is successfully translated if at least a portion of the message content could be translated into a format that is compatible for display by a recipient messaging system through its user interface. For example, a message is not successfully translated if none of the portion of the message content could be translated into a format that is compatible for display by a recipient messaging system through its user interface.

At 514, whether the message requests to create a new action is determined. In the event that the message requests to create a new action, control is transferred to 522. Otherwise, in the event that the message does not request to create a new action, control is transferred to 516. For example, the message may include a request to create a new action/sub-thread if the sender user had used the message proxy plugin corresponding to the message user interface that was provided by the first messaging system to initiate a new action. As mentioned above, the new action may include a request to the members of the message thread that are associated with another messaging system and/or a different organization. Messages that are then posted in relation to the new action associated with the message can be organized and presented within a separate window than the window at which all messages of the message thread are visible to a member of the message thread within the user interface of the messaging system that he or she is using. The separate window presentation allows message thread members to easily locate all the messages that pertain to the action while they can also check on the current status of the action.

At 516, whether the message is related to an existing action is determined. In the event that the message is related to an existing action, control is transferred to 528. Otherwise, in the event that the message is not related to an existing action, control is transferred to 518. If the message was posted/submitted to the separate window of the first messaging system's user interface that is related to the existing/previously created action, then the action is determined to be associated with an existing action/sub-thread.

At 518, the second messaging system is instructed to post the translated message to the message thread directly. The translated message is transmitted to the second messaging system and associated with the second messaging system object related to the message thread. The result of associating the translated message with the recipient/second messaging system object related to the message thread is that the message will be distributed by the second messaging system to the user devices of the members of the message thread and are also users of the message thread. Such a message will be presented within the main window of the recipient/second messaging system's user interface (unlike the separate window that is used to present sub-thread/action-specific messages).

At 520, an error message is returned. If the message could not be successfully translated, then it cannot be sent to a recipient messaging system.

At 522, information corresponding to the new action is stored. Information related to the request associated with the new action is stored. For example, the stored information may include one or more of the following: which message thread member had created the action, the deadline associated with the action, and whether the current status associated with the action is open or closed. In some embodiments, if a user closes an action, then it is assumed that the action is either completed or canceled. In some embodiments, if the action is not closed within a predetermined number of days in advance of the deadline, then the message proxy server is configured to send a reminder to at least a portion of the message thread members.

At 524, the first messaging system is instructed to create a first sub-thread object associated with a new sub-thread of the message thread corresponding to the new action. In response to the determination that a new action is requested, the message proxy server is configured to instruct the first messaging system to create a sub-thread object corresponding to the new action/sub-thread of the message thread using the first messaging system's API. The sub-thread object can be used by the first messaging system to track messages that are submitted to that sub-thread.

At 526, the second messaging system is instructed to create a second sub-thread object associated with the new sub-thread of the message thread and the translated message is posted to the new sub-thread. In response to the determination that a new action is requested, the message proxy server is also configured to instruct the second messaging system to create a sub-thread object corresponding to the new action/sub-thread of the message thread using the second messaging system's API. The sub-thread object can be used by the second messaging system to track messages that are submitted to that sub-thread.

At 528, the translated message is posted to an existing sub-thread of the message thread corresponding to the existing action. The translated message is transmitted to the second messaging system and associated with the second messaging system sub-thread object related to the existing action/sub-thread of the message thread. The result of associating the translated message with the recipient/second messaging system action/sub-thread related to the requested action is that the message will be distributed by the second messaging system to the user devices of the members of the message thread and are also users of the message thread. Such a message will be presented within the separate window of the recipient/second messaging system's user interface that is dedicated to presenting messages that are specific to that sub-thread/action.

While not described in process 500, the message may include a mention of another member of the message thread. To whom the sender user can provide a mention or directly message is governed by the sender user's own persona. If the sender user's persona does not permit them to mention or directly message “Alice Jones.” then the disallowed contact will be automatically populated as a candidate message target into the first messaging system's user interface in a concept that is sometimes referred to as an “address book,” which will be described in further detail below. Otherwise, if the sender user's persona does permit them to mention or directly message “Alice Jones,” then the allowed contact will be automatically populated as a candidate message target into the first messaging system's user interface. Once “Alice Jones” is selected as an individual for mentioning or directly messaging, then the “Alice Jones” can be directedly notified on her user device (e.g., via a notification on the messaging system user interface that is provided to the individual).

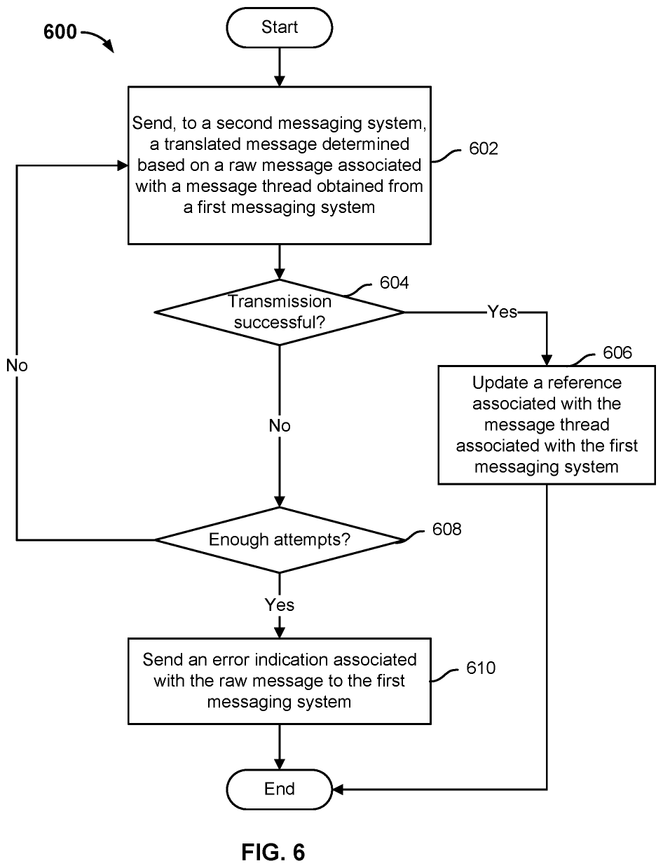

FIG. 6 is a flow diagram showing an example of a process of message transmission in accordance with some embodiments. In some embodiments, process 600 is implemented, at least in part, by a message proxy server such as message proxy server 102 of FIG. 1. In some embodiments, step 518 of process 500 of FIG. 5 is implemented, at least in part, using process 600.

Process 600 describes an example process for retrying to send a translated message from a first messaging system to a second messaging system in the event that a previous attempt did not succeed.

At 602, a translated message determined based on a raw message associated with a message thread obtained from a first messaging system is sent to a second messaging system. The translated message is determined based on translating the content of the raw/untranslated message and the identity of its sender user. The message proxy server transmits the translated message that is received from a first messaging system member of a message thread by instructing (e.g., using an API) a destination, second messaging system to associate/post the translated message with the second messaging system object corresponding to that message thread.

At 604, whether the transmission was successful is determined. In the event that the transmission was successful, control is transferred to 606. Otherwise, in the event that the transmission was not successful, control is transferred to 608. For example, the translated message may not be successfully transmitted to the second messaging system in the event that the second messaging system is experiencing a temporary outage or other disruption to service. For example, an unsuccessful transmission of the translated message can be determined based on a lack of receiving an acknowledgement of successful posting of the translated message from the second messaging system beyond a predetermined timeout period.

At 606, a reference associated with the message thread associated with the first messaging system is updated. In various embodiments, because the message proxy server is a stateless server and does not persist or cache messages after translating and transmitting them to one or more destination messaging systems, the message proxy server is configured to store references to keep track of which raw messages associated with the message thread at the first messaging system have been successfully transmitted to the one or more destination messaging systems and which have not. For example, where a messaging system organizes messages associated with a message thread deterministically (e.g., in chronological or reverse chronological order) in a data structure (e.g., a queue or a list), the message proxy server can track which raw messages that they still need to translate and transmit to one or more destination messaging systems by storing a reference (e.g., pointer) to the next message at the originating messaging system that needs to be translated and transmitted to one or more destination messaging systems. As such, if a message associated with the originating messaging system has not yet been successfully translated and transmitted to one or more destination messaging systems, then the message proxy server would still store a reference (e.g., a pointer) to that message, which will lead to a subsequent translation and transmission attempt of the message to the destination messaging systems at step 602, providing that the threshold number of transmission attempts has not been met, as described at step 608. Only after a raw message has been successfully translated and transmitted to one or more destination messaging systems, will the reference (e.g., pointer) be updated (e.g., shifted) to refer/point to the next unsent raw message in the data structure. By updating the reference to refer to the next unsent raw message in the data structure, the message proxy server will next attempt to translate and transmit that next message to the destination messaging system(s).

At 608, whether there has been at least a threshold number of transmission attempts of the translated message is determined. In the event that there has been at least a threshold number of transmission attempts of the translated message, control is transferred to 610. Otherwise, in the event that there has been less than a threshold number of transmission attempts of the translated message, control is returned to 602. In various embodiments, the predetermined number of attempts to transmit a translated message to one or more destination messaging systems is set such that once this number of attempts is exceeded, an error indication associated with the transmission of this message is returned to the first messaging system.

At 610, an error indication associated with the raw message is sent to the first messaging system. In response to the error indication associated with the raw message that was not able to be successfully transmitted to the destination, second messaging system after a predetermined number of attempts, the first messaging system may send to the user devices associated with users of the first messaging system that are members of the message thread indications that the message had failed to send.

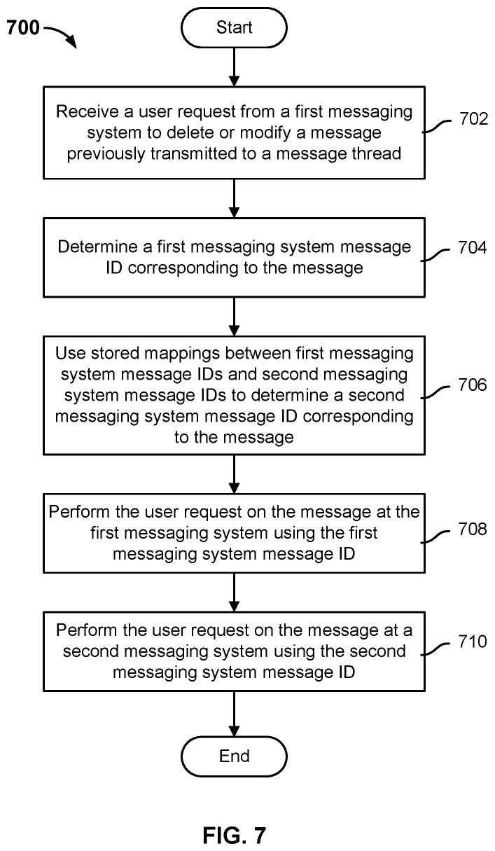

FIG. 7 is a flow diagram showing an example of a process of modifying or deleting a message on a message thread in accordance with some embodiments. In some embodiments, process 700 is implemented, at least in part, by a message proxy server such as message proxy server 102 of FIG. 1.

Process 700 describes an example process for modifying or deleting a message that was posted to a message thread and also transmitted from a first messaging system to a second messaging system.

At 702, a user request is received from a first messaging system to delete or modify a message that was previously transmitted to a message thread. After a message is posted by a user of the first messaging system to the message thread, the user can submit a modification to the message or request to delete the message. In the event that the message was one that was also transmitted to a destination, second messaging system, and then posted to members of the message thread that are users of the second messaging system, a modification of the message at the originating messaging system is also propagated to the message at the destination, second messaging system.

At 704, a first messaging system message ID corresponding to the message is determined. Because each message is assigned a messaging system message ID that is assigned by the messaging system at which it was first received, the first messaging system message ID corresponding to the affected message that was initially posted to the first messaging system is determined.

At 706, stored mappings between first messaging system message IDs and second messaging system message IDs are used to determine a second messaging system message ID corresponding to the message. As mentioned above, the message proxy server stores mappings between first messaging system message IDs and second messaging system message IDs of messages that are transmitted from one messaging system to the other. As such, after the first messaging system message ID corresponding to the affected message is determined, the stored mappings are used to determine the corresponding second messaging system message ID corresponding to the affected message.

At 708, the user request is performed on the message at the first messaging system using the first messaging system message ID. The message proxy server can use the first messaging system message ID corresponding to the affected message to instruct the first messaging system to perform the requested modification/deletion on the message at the first messaging system using an API provided by the first messaging system.

At 710, the user request is performed on the message at the second messaging system using the second messaging system message ID. The message proxy server can use the second messaging system message ID corresponding to the affected message to instruct the second messaging system to perform the requested modification/deletion on the message at the second messaging system using an API provided by the second messaging system.

The result of having instructed the first and second messaging systems to perform the requested modification/deletion on the affected message is that the modified message can symmetrically appear or the deleted message can symmetrically disappear from the respective user interfaces that are provided by the first and second messaging systems to their respective users that are members of the message thread.

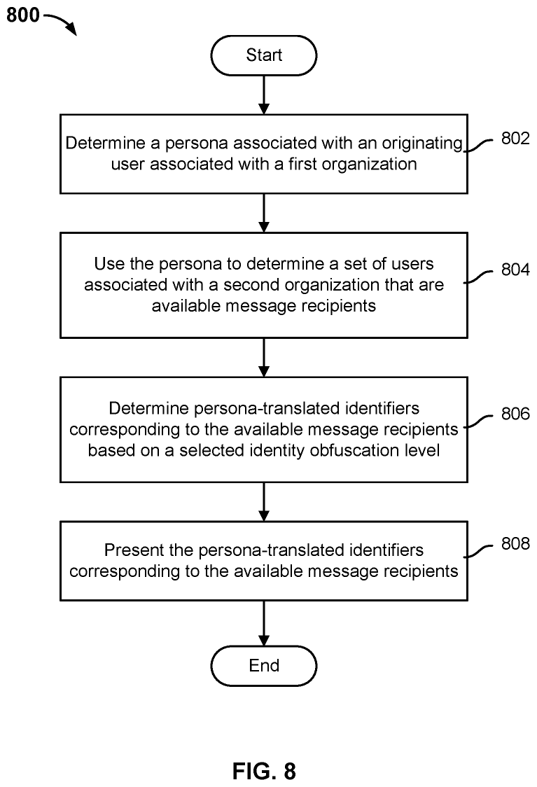

FIG. 8 is a flow diagram showing an example of a process of implementing an address book for an originating user of a message in accordance with some embodiments. In some embodiments, process 800 is implemented, at least in part, by a message proxy server such as message proxy server 102 of FIG. 1.

Process 800 describes an example process of determining, for a message originating user, an address book which identifies other users that are available to being mentioned by the originating user in a message to be posted on the message thread or to directly message outside of the message thread given the original user's persona and the personas of the other users. In some embodiments, process 800 can be triggered in response to an originating user typing in a symbol (e.g., “@”) in an input field of a messaging system user interface or in response to the originating user selecting to send a direct message using the messaging system user interface.

At 802, a persona associated with an originating user associated with a first organization is determined.

At 804, the persona is used to determine a set of users associated with a second organization that are available message recipients. Because the persona that was assigned to the originating user that is associated with the first organization is associated with permissions with respect to which other personas that the former can directly message or mention in a message in a message thread, only those other users that are associated with personas for which the former have permission to contact form available candidate message recipients. The other users could be associated with an organization that is different than the one with which the originating user is associated and the other users could also be members of a message thread for which the originating user is also a member. For example, an originating user of Persona Type A is only permitted to directly message or mention users of Persona Types B or C and so the subset of other users (of a different organization and/or is a counter party to an organization-to-organization relationship) that are of Persona Types B or C are determined to be available message recipients relative to the originating user of Persona Type A.

At 806, persona-translated identifiers corresponding to the available message recipients are determined based on a selected identity obfuscation level. Depending on the selected identity obfuscation level associated with the message thread and/or the organization-to-organization relationship between the first and second organizations, the identities of the available message recipients may need to be first obfuscated before they are presented within the address book to the originating user at the user interface of the messaging system that is used by the originating user. For example, if the originating user is associated with Persona Type 1 and the selected identity obfuscation level dictates that the user identity of each available message recipient can only show the user's persona type followed by a unique value, then the available message recipients for the originating user can be presented as “Persona Type B 1, Persona Type B 2, Persona Type C 3, Persona Type C 4” and so forth.

At 808, the persona-translated identifiers corresponding to the available message recipients are presented. The persona-translated identifiers of the available message recipients can be presented to the originating user for the user to select one or more such available message recipients to which to mention in a message thread message or to directly message.

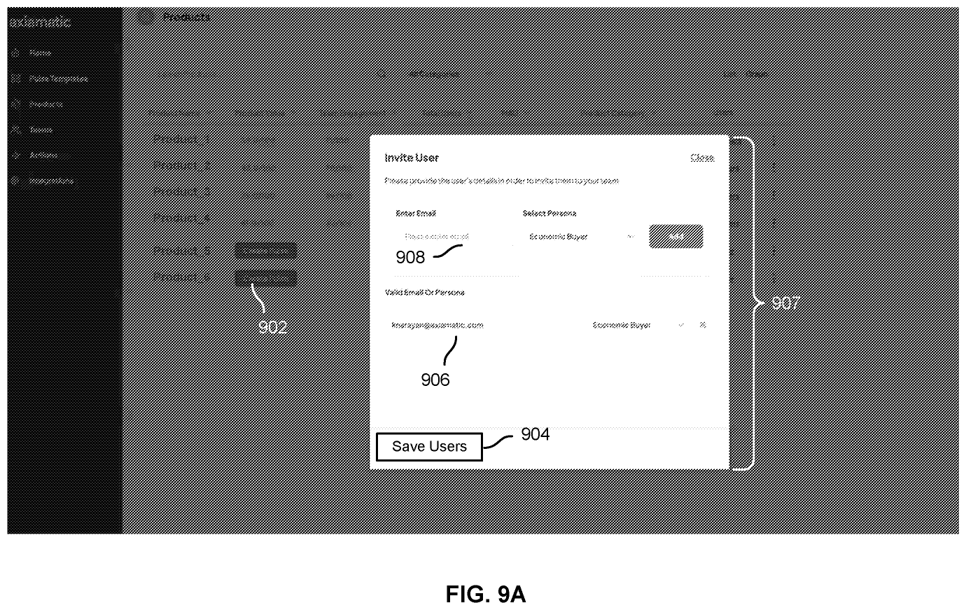

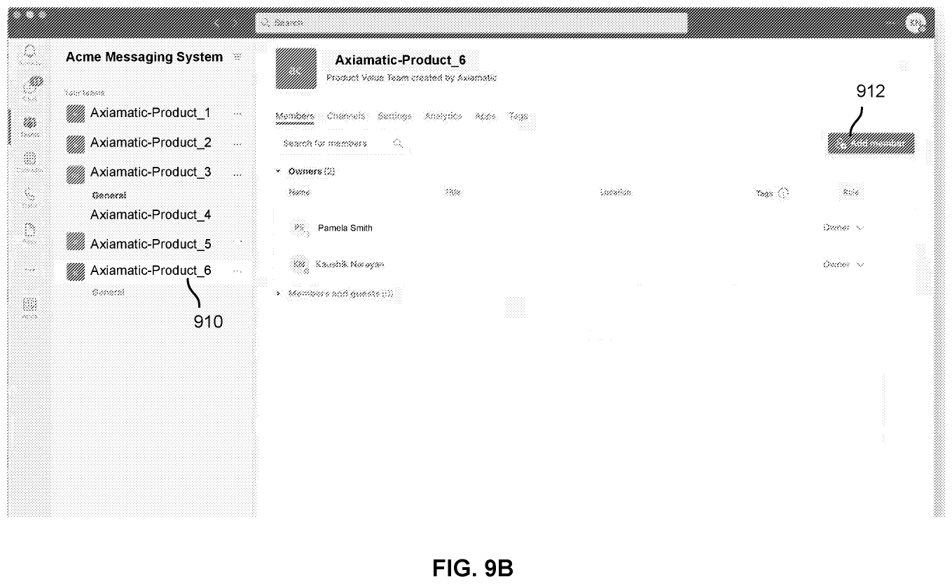

FIGS. 9A and 9B show example user interfaces that can be provided by a message proxy server to enable a user to create a new message thread.

FIG. 9A shows an example of a user interface that can be provided by a message proxy server to invite a user to create a new message thread that pertains to a selected product. In the example of FIG. 9A, the user is associated with a first organization that uses a product called “Product_6,” which is provided by a second, vendor organization. In order to provide feedback and/or make requests of the vendor/second organization, the user of the first organization engages with the example user interface that is presented in FIG. 9A and selects “Create Pulse” element 902 corresponding to “Product_6” to cause a new message thread to be created between user(s) at the first organization (customer) and user(s) of the vendor (the second organization) of “Product_6.” In response to the selection of “Create Pulse” element 902 corresponding to “Product_6,” window 907 is presented to allow the user to add members of the first organization to the message thread. For example, each member of the first organization can be added by email at field 908 and their corresponding persona can also be selected from a menu. Once a member is successfully added, their corresponding email and persona are shown at 906. Once all the members of the first organization are added at window 907, the user can select “Save Users” element 904 to save the added members to the new message thread. While not shown in FIG. 9A, the user of the first organization that had initiated the creation of the message thread can also select, at a user interface provided by the message proxy server, a messaging system that is to be used by the first organization members of the message thread to interface with the message thread.

FIG. 9B shows an example of a user interface that can be provided by a messaging system to display the current members of any message thread that are associated with a particular organization. For example, the user interface of FIG. 9B can be presented by the messaging system that is selected by a user of the first organization sometime after the user had interacted with the user interface of FIG. 9A to create a new message thread. In the example of FIG. 9B, the user of the first organization had selected to use “Acme” as the messaging system that message thread members of the first organization were going to use to interface with the message thread. In particular, in FIG. 9B, the user had selected tab 910 associated “Axiamatic-Product_6”, which is the name of the message thread that was created using the user interface of FIG. 9A, to view the current members (“Pamela Smith” and “Kaushik Narayan”) of the first organization that were added to that message thread. To add additional users from the first organization as members of the message thread, the user can select “Add member” element 912.

While not shown in FIGS. 9A and 9B, similar user interfaces to those shown in FIGS. 9A and 9B can be presented to a user at the vendor/second organization to enable that user to invite users from a second organization to be added as members to the “Axiamatic-Product_6” message thread and to select a messaging system that the second organization members will use to interface with the message thread.

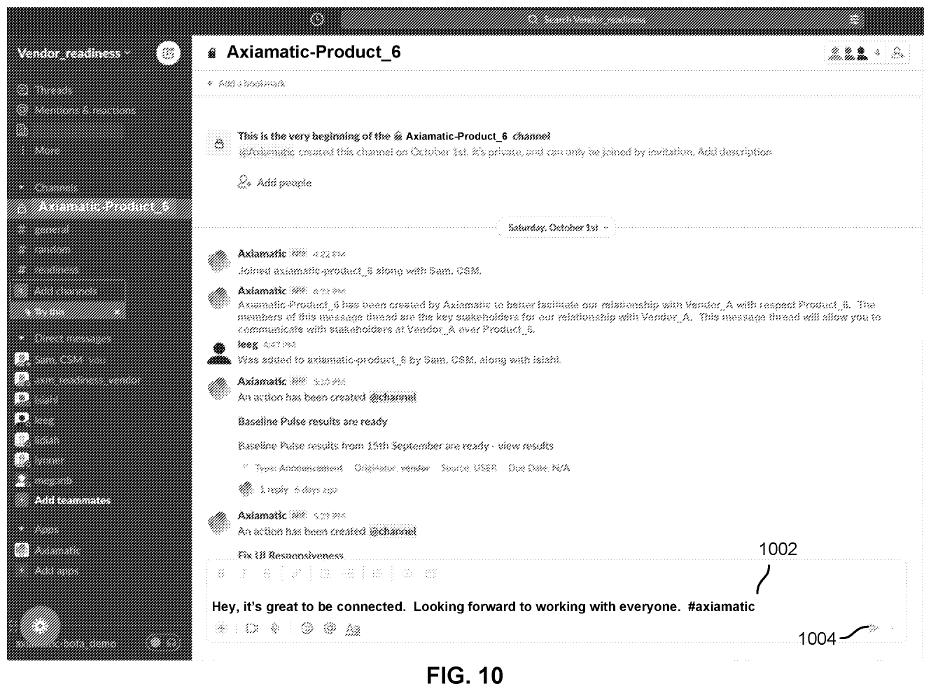

FIG. 10 is a diagram showing an example user interface that is provided by a messaging system that a member of a message thread has selected to use to interface with the message thread. The user interface of FIG. 10 shows messages that are posted to the message thread titled “Axiamatic-Product_6” by members of that thread and other updates with respect to the message thread. The example user interface of FIG. 10 can be presented at a user device (e.g., a laptop, a computer, or a mobile device) by the messaging system that is used by members of the “Axiamatic-Product_6” message thread and that are all personnel of a first organization. The example user interface of FIG. 10 presents the main window for the feed of messages that have been posted to the message thread. To post a new message to the “Axiamatic-Product_6” message thread, a user can input the message (comprising text, images, audio, and/or video) into input field 1002. In the example of FIG. 10, the user has already input into input field 1002 the text “Hey, it's great to be connected. Looking forward to working with everyone. #axiamatic” Once the user submits this message by selecting submission element 1004, the message is sent by the user device to the messaging system. The message proxy server is configured to detect this message and determine how to process it using a process such as process 500 of FIG. 5. The message proxy server is then configured to determine whether this message is to be transmitted to another messaging system that has users that are also members of the “Axiamatic-Product_6” message thread. For example, the message proxy server determines that this message is to be transmitted to one or more other messaging systems that have users that are also members of the “Axiamatic-Product_6” message thread by detecting the presence of the predetermined text within the message (e.g., “#axiamatic”) that indicates that this message is to be publicly shared with message thread members across different messaging systems (as opposed to kept private to only members of the same messaging system). In response to a determination that the message is to be transmitted to the other messaging system(s), the message proxy server is configured to translate the message content in accordance with the message formatting of the destination messaging system(s). The message proxy server is further configured to obfuscate the user identifier of the sender of the message based on the selected identity obfuscation level associated with the “Axiamatic-Product_6” message thread. The translated message (including the translated message content and the obfuscated sender user identity) is then sent from the message proxy server to each of the destination messaging systems, which will be configured to distribute the translated message to the user device of each of its users that are members of the “Axiamatic-Product_6” message thread. Each such recipient would be presented with the translated message within the user interface that is provided by the respective destination messaging system.

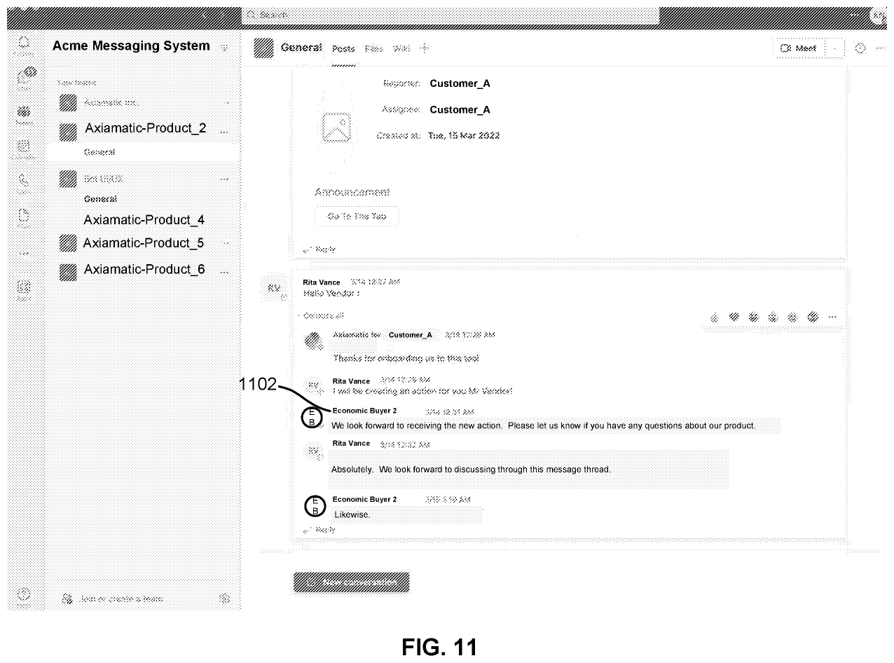

FIG. 11 is a diagram showing an example user interface that is provided by a messaging system that a member of a message thread has selected to use to interface with the message thread. In the example of FIG. 11, the user to whom the user interface is presented is “Rita Vance” and as such, Rita is able to view her full name associated with messages that she had posted to the message thread using the messaging system named “Acme.” However, the identities of other users/members of the message thread that had posted/sent messages to the message thread are obfuscated based on their respective personas and the selected identity obfuscation level that they are associated with. While Rita is associated with a customer organization that is using Acme messaging system to interface with the message thread, the members of the message thread that are part of the vendor organization could be using a different messaging system to interface with the message thread. For example, as shown in FIG. 11, Rita and another member from the vendor organization have both posted messages below one of Rita's own messages (“Hello Vendor !”). Given that the selected identity obfuscation level for the message thread dictates for the message proxy server to obfuscate a sender user's identity into the sender user's persona followed by a unique numerical value, the other member with whom Rita had exchanged messages below Rita's “Hello Vendor !” message is displayed as “Economic Buyer 2” 1102 at the user interface that is presented to Rita. As such, while Rita can deduce that this other message thread member has the persona type of “Economic Buyer,” Rita cannot infer any personally identifiable information about this other individual. Nevertheless, Rita can still be assured that each time a message is sent by “Economic Buyer 2,” the message is originated from the same individual versus another user that also shares the persona of an “Economic Buyer.”

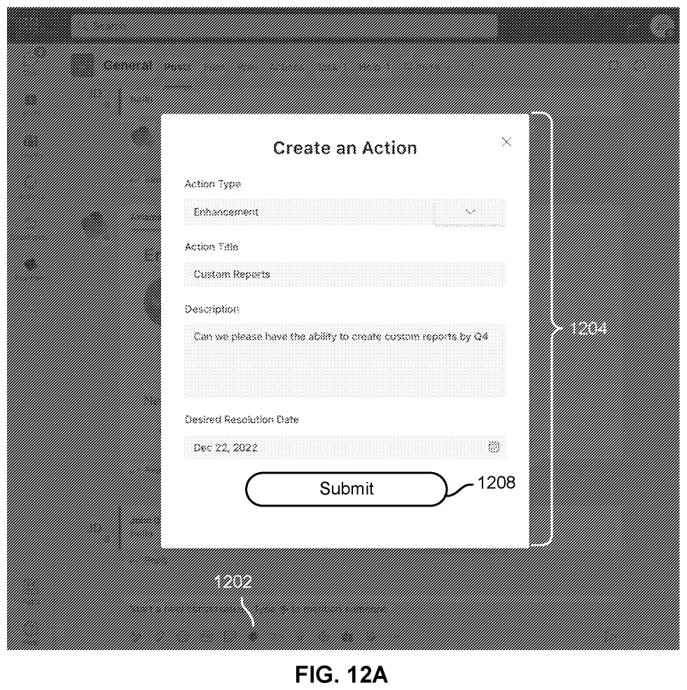

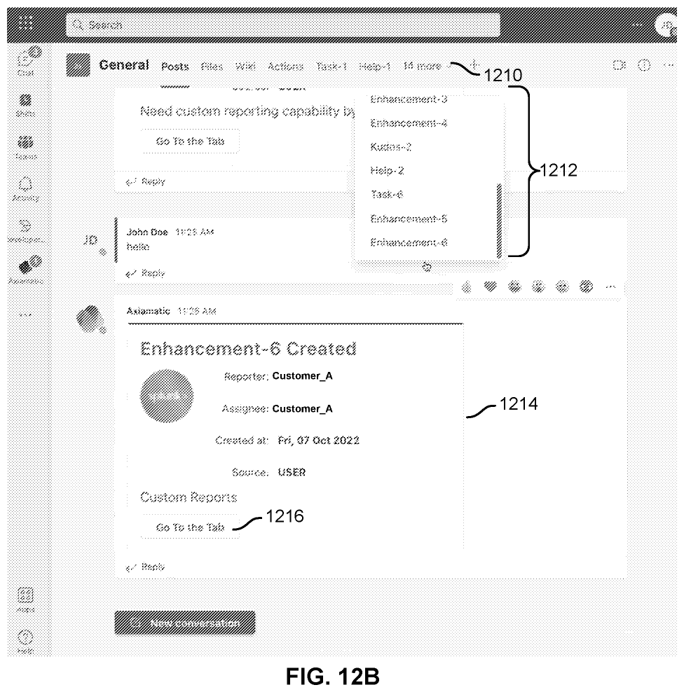

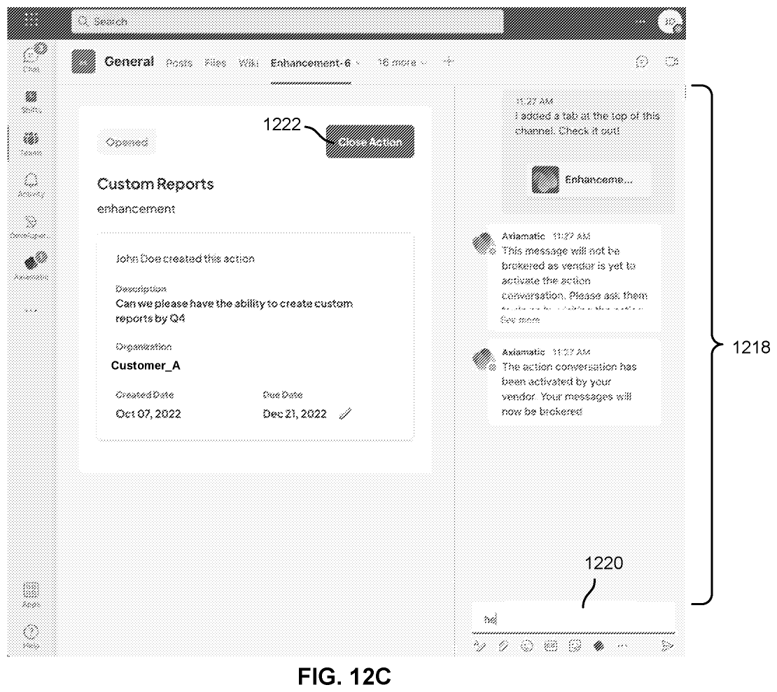

FIGS. 12A-12C describe example user interfaces associated with creating a sub-thread related to a new action within a message thread.

FIG. 12A is a diagram showing an example user interface that is provided by a messaging system that a member of a message thread has selected to use to interface with the message thread and at which the user has selected to create a new sub-thread corresponding to a new action. In some embodiments, to enable a new sub-thread, which is associated with a message thread for which messages are proxied by the message proxy server, to be created at a user interface that is provided by a messaging system, a plugin for software associated with the messaging system is first downloaded from the message proxy server. Once installed at a user device, the plugin will create additional features at the native user interface of the messaging system that the user can interact with to perform functions like create a new sub-thread in an existing message thread. As mentioned above, a sub-thread, such as corresponding to a particular action, can be created within a message thread to track messages that are related to a particular topic. In example of FIG. 12, the user had selected action creation element 1202 to cause action creation window 1204 to be presented. Using action creation window 1204, the user can customize the type of action that they want to create, a title for the action, a description of the requested action, and the date by which they desired the action to have been completed. In the example user interface of FIG. 12A, the user is part of a customer organization (Customer_A) that has requested to create an action (e.g., a new feature) to be completed by a vendor organization for which some users were also members of the same message thread. After the user has completed the fields within action creation window 1204 and selects submit element 1208, the message proxy server can instruct, via APIs, the messaging systems that the message thread members used to interface with the message thread to create respective sub-thread objects corresponding to their respective message thread object.

FIG. 12B is a diagram showing an example user interface that is provided by a messaging system after the creation of a sub-thread corresponding to a new action. The user interface of FIG. 12B can be presented in response to the user creation of a new action using the example user interface of FIG. 12A. The user interface of FIG. 12B shows the creation of new action 1214, which is named “Enhancement-6 Created” within the main window/feed of messages that have been submitted in the current message thread. To jump to the separate window that shows only messages that are specific to the “Enhancement-6 Created” action, the user can select “Go To the Tab” 1216 element within new action presentation 1214 in the main window or select “Enhancement-6” among the list of action options 1212 that is presented in response to the user's selection of “14 more” tab 1210.

FIG. 12C is a diagram showing an example user interface that is provided by a messaging system to present a separate window that includes messages that relate to the sub-thread corresponding to the new action. The user interface of FIG. 12C can be presented by the messaging system in response to the user selection of either “Go To the Tab” 1216 element within new action presentation 1214 in the main window or “Enhancement-6” among the list of action options 1212 in the example user interface of FIG. 12B. The user interface of FIG. 12C is a window separate from the main window associated with the message thread (e.g., the user interface that was shown in FIG. 12B). The user interface of FIG. 12C shows details regarding the relevant action of “Enhancement-6” such as the action type, the action creator user and organization, the date of creation, and the due date for the action. The user interface of FIG. 12C simultaneously shows the feed of messages 1218 that are specifically related to the relevant action (“Enhancement-6”). A user can send a message related to the action of “Enhancement-6” via input field 1220. The message proxy server will instruct the messaging systems for which users are members of the message thread to associate the messages sent via input field 1220 with the messaging systems' respective sub-thread objects related to the action of “Enhancement-6.” As a result, these messages will also be presented within the action/sub-thread's own feed of messages 1218. For example, members of the message thread can exchange messages specifically related to the action of “Enhancement-6” within the separate window shown in FIG. 12C without needing to manually search through all the messages of the message thread for the subset that is relevant to the action. In addition, a member of the message thread can also update the current status of the action by interacting with the user interface of FIG. 12C. As shown in FIG. 12C, the user can select “Close Action” 1222 to close the action (if the requested action has been completed). While not shown in FIG. 12C, the user may also be able to perform different updates to the action besides closing the action such as, for example, request feedback on the action and review the action.

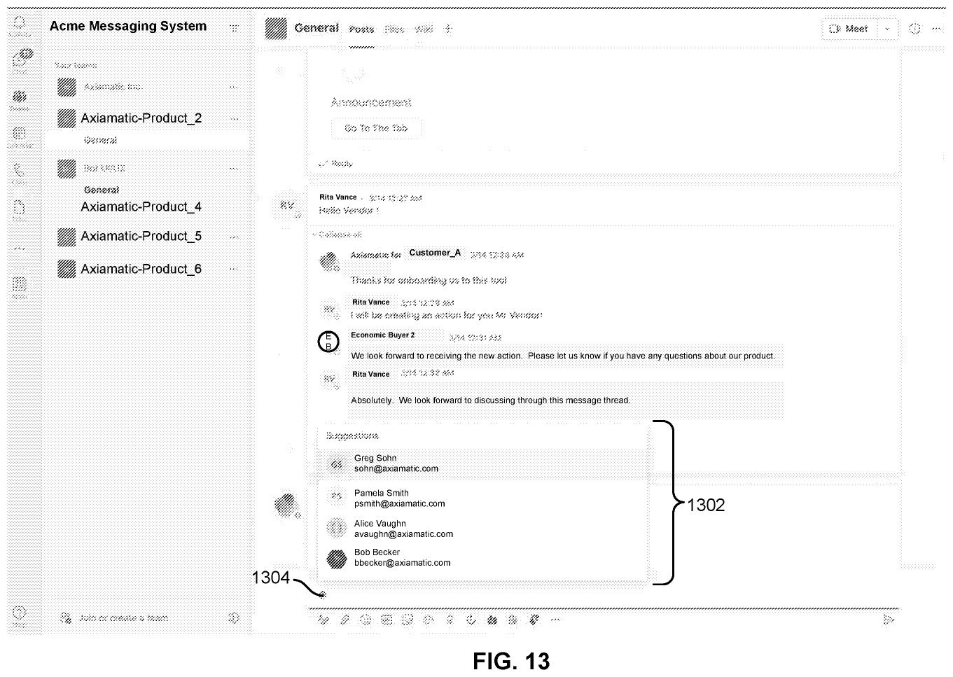

FIG. 13 is a diagram showing an example user interface that is provided by a messaging system and at which the address book of the user is used to determine the available message recipients that the user can mention in a message to a message thread. The user for which the example user interface of FIG. 13 is presented has entered into input field 1304 a symbol (“@”) that has been designated to create a mention of one or more other members of the message thread. In response to the detection of the designated symbol in input field 1304, the message proxy server is configured to dynamically determine the address book of the user that is composing the message using a process such as process 800 of FIG. 8. Determining the address book of the user comprises identifying available message recipients to whom the composing user is permitted to mention within a message based on that user's persona. The available message recipients that the composing user is permitted to mention within a message are presented within list 1302. While the user identities of available message recipients within list 1302 are presented without obfuscation, depending on the selected identity obfuscation level that is configured for a message thread, the user identities of available message recipients could be first obfuscated before they are presented to the composing user. The user that is composing the message can then select one or more of the presented available message recipients to mention in the message and the consequence of which is that the mentioned user will receive an additional notification or prompt about this particular message in which they have been mentioned.

Although the foregoing embodiments have been described in some detail for purposes of clarity of understanding, the invention is not limited to the details provided. There are many alternative ways of implementing the invention. The disclosed embodiments are illustrative and not restrictive.

1. A message proxy server, comprising:
a memory; and
a processor coupled to the memory and configured to:
receive a message sent from a user of a first messaging system, wherein the first messaging system is associated with a first messaging platform;
associate the message with a message thread;
translate the message based at least in part on a persona associated with the user;
transmit the translated message to a second messaging system, wherein the second messaging system is associated with a second messaging platform, wherein the second messaging platform is different from the first messaging platform;
determine that the translated message has been successfully transmitted to the second messaging system; and
in response to the determination that the translated message has been successfully transmitted to the second messaging system, update a reference to track a last successfully transmitted message of the message thread associated with the first messaging system.

2. The message proxy server of claim 1, wherein the user comprises a third user, and wherein the processor is further configured to:
receive, from a first user associated with a first organization, a selection of a second organization with which to form the message thread;
receive, from the first user, a selection of the first messaging system from which to interface with the message thread;
receive, from the first user, identifiers associated with a first set of users associated with the first organization to be associated with the message thread and personas to be associated with the first set of users;
receive, from the first user, an identity obfuscation level to be associated with the message thread; and
instruct the first messaging system to generate a first message thread object associated with the first set of users.

3. The message proxy server of claim 2, wherein the processor is further configured to:
receive, from a second user associated with the second organization, a selection of the second messaging system from which to interface with the message thread;
receive, from the second user, identifiers associated with a second set of users associated with the second organization to be associated with the message thread and personas to be associated with the second set of users; and
instruct the second messaging system to generate a second message thread object associated with the second set of users.

4. The message proxy server of claim 1, wherein the processor is further configured to determine whether to transmit the message to the second messaging system based at least in part on whether the message includes predetermined text.

5. The message proxy server of claim 1, wherein to translate the message based at least in part on the persona associated with the user includes to translate content of the message in accordance with message formatting associated with the second messaging system.

6. The message proxy server of claim 1, wherein to translate the message based at least in part on the persona associated with the user includes to obfuscate a user identity of the user based at least in part on a selected identity obfuscation level associated with the message thread.

7. The message proxy server of claim 1, wherein the processor is further configured to determine whether the message comprises a request to create a new action or is related to an existing action.

8. The message proxy server of claim 7, wherein the processor is further configured to:
in response to a determination that the message comprises the request to create the new action:
instruct the first messaging system to create a first sub-thread object associated with a new sub-thread of the message thread corresponding to the new action; and
instruct the second messaging system to create a second sub-thread object associated with the new sub-thread of the message thread corresponding to the new action.

9. The message proxy server of claim 7, wherein the processor is further configured to store a current status of the new action.

10. The message proxy server of claim 7, wherein the processor is further configured to in response to a determination that the message is related to the existing action, instruct the second messaging system to associate the message with a sub-thread object associated with an existing sub-thread of the message thread corresponding to the existing action.

11. (canceled)

12. The message proxy server of claim 1, wherein the message is not persisted at the message proxy server.

13. The message proxy server of claim 1, wherein the processor is further configured to:
receive a user request from the first messaging system to delete or modify the message that was transmitted to the second messaging system;
determine a first messaging system message identifier corresponding to the message;
use stored mappings between first messaging system message identifiers and second messaging system message identifiers to determine a second messaging system message identifier corresponding to the message;
perform the user request on the message at the first messaging system using the first messaging system message identifier; and
perform the user request on the message at the second messaging system using the second messaging system message identifier.

14. The message proxy server of claim 1, wherein the user is associated with a first organization, and wherein the processor is further configured to:
use the persona to determine a set of users associated with a second organization that are available message recipients relative to the user;
determine persona-translated identifiers corresponding to the available message recipients based at least in part on a selected identity obfuscation level; and
present the persona-translated identifiers corresponding to the available message recipients.

15. A method, comprising:
receiving a message sent from a user of a first messaging system, wherein the first messaging system is associated with a first messaging platform;
associating the message with a message thread;
translating the message based at least in part on a persona associated with the user;
transmitting the translated message to a second messaging system, wherein the second messaging system is associated with a second messaging platform, wherein the second messaging platform is different from the first messaging platform;
determining that the translated message has been successfully transmitted to the second messaging system; and
in response to the determination that the translated message has been successfully transmitted to the second messaging system, updating a reference to track a last successfully transmitted message of the message thread associated with the first messaging system.

16. The method of claim 15, wherein translating the message based at least in part on the persona associated with the user includes obfuscating a user identity of the user based at least in part on a selected identity obfuscation level associated with the message thread.

17. The method of claim 15, further comprising determining whether the message comprises a request to create a new action or is related to an existing action.

18. The method of claim 17, further comprising storing a current status of the new action.

19. The method of claim 15, wherein the message is not persisted at a message proxy server.

20. A computer program product, the computer program product being embodied in a non-transitory computer readable storage medium and comprising computer instructions for:
receiving a message sent from a user of a first messaging system, wherein the first messaging system is associated with a first messaging platform;
associating the message with a message thread;
translating the message based at least in part on a persona associated with the user;
transmitting the translated message to a second messaging system, wherein the second messaging system is associated with a second messaging platform, wherein the second messaging platform is different from the first messaging platform;
determining that the translated message has been successfully transmitted to the second messaging system; and
in response to the determination that the translated message has been successfully transmitted to the second messaging system, updating a reference to track a last successfully transmitted message of the message thread associated with the first messaging system.
